(19) United States
(12) Patent Application Publication
(10) Pub. No.: US 2008/0155479 A1
(43) Pub. Date: Jun. 26, 2008

(54) Method and Apparatus for Building Interactive Software Applications

(76) Inventors: Mark Long, Los Angeles, CA (US); Paul Dimitruk, Las Vegas, NV (US); Christian Maas, Los Angeles, CA (US); Mark Auburn, Manhathan Beach, CA (US)

Correspondence Address: DLA PIPER US LLP, 1999 AVENUE OF THE STARS, SUITE 400, LOS ANGELES, CA, 90067-6023, US

(21) Appl. No.: 11/672,915

(22) Filed: Feb. 8, 2007

Related U.S. Application Data
(60) Provisional application No. 60/871,726, filed on Dec. 22, 2006.

(51) Int. Cl. G06F 3/048

(52) U.S. Cl. 715/854

(57) ABSTRACT

The system provides an application builder and an application player. The application builder is used to intuitively generate interactive software applications and can be operated by one or more subject matter experts with or without programming experience. By providing a natural framework for software generation, the system provides greater accessibility to those who can most benefit from the creation of an interactive software. The application player is designed to interface easily with the application builder so that a functional product can be quickly used. The application builder is accessed through interfaces defining a Data Model, a Presentation, and Navigation (or WorkFlow).

### APPLICATIONS

This application claims priority to U.S. Provisional patent application 60/871,726 filed Dec. 22, 2006 entitled “Method and Apparatus for Building Interactive Software Applications” and which is incorporated by reference in its entirety herein.

### BACKGROUND

1. Field

The system relates to the field of automatically building software applications.

2. Background

There are a spectrum of approaches to developing any computer application. Writing custom software code is the most flexible, but is often the most costly. It also has higher lifecycle costs as the requirements change over time. As the pace of change in technology and business accelerates it is rare that the specifications and requirements for a computer application remain fixed long enough to complete the product. On the opposite end of the spectrum are purpose built tools. There are a number of content management systems, online survey tools, data modelling tools (e.g. Excel) and eLearning suites that once you get beyond the cost of the software itself offer the ability to create and maintain simple computer applications very quickly. However, these tools are often designed for the lowest common denominator and thus have limited flexibility to do anything beyond their defined purpose.

There are a number of methods for creating software programs that are designed for use by professional programmers. Procedure-based programming is a technique that can create large, monolithic applications that have to be rewritten, recompiled, and tested each time even the smallest change is made. This process can take months or years but is a typical approach for commercial software applications. A disadvantage of this type of programming is the need for highly trained programmers and developers since the person specifying the desired functionality does not understand the language in which their intent is expressed and cannot validate through inspection that the desired functionality was captured correctly.

One prior art attempt to provide a more accessible environment for the creation of software applications is the use of object-oriented programming. Object oriented programming schemes such as Corba, Enterprise Java-Beans, and Microsoft's COM all promise a high degree of code reuse through the use of modular components. The problem with these modular components is they are designed to follow the patterns and metaphors common to a professional programmer not the consumer of the application. The code surrounding the components which ties them together has to be constructed manually by a programmer or developer, and the components are flexible only to the extent that the component authors anticipated requirements for flexibility and built that into their code at design time. Object-oriented programming falls short of capturing the process that developers follow building the application and captures only the explicit results in source code. The same is true for Java servlets. They are hard to modify and to maintain.

One prior art approach to the creation of knowledge-based systems is a product known as Corvid by EXSYS, Inc. of Albuquerque, N.M. While applications can be created without procedural programming and metaphors used by professional developers, it instead uses the metaphor of a person with artificial intelligence experience.

All of these approaches fail to create an application authoring and editing practice in a mode accessible to a non professional programmer. The software design point is wrong—business practices are being encoded at too deep a level. Rather than allowing application specifications to be captured at a high level, these systems focus on encoding practices at a low level, where many assumptions and decisions are made by the developers and many goals of the end user are unsatisfied.

### SUMMARY

The system provides an application builder and an application player. The application builder (also may be referred to as an “authoring tool”) is used to intuitively generate an interactive software application by one or more people with or without programming experience. By providing a natural framework for software generation, the system provides greater accessibility to those who can most benefit from the creation of a software application. The application player is designed to use the results of the application builder so that a usable product can be quickly deployed.

The system uses a presentation, navigation, calculation metaphor for generating applications. The applications generated by the application builder include a Presentation Layer (using XML adaptable to changing conditions in one embodiment), a navigation system, and a Data Structure (Decision Logic Layer) capable of handling dimensionalized data sets and chaining (forward and backward) rule combinations (i.e. calculation). These layers interact in various ways as customers use an application, creating updated results and dynamic navigation to lead users to critical insights and results.

The Data Structure includes data and the logic, rules, and formulas that derive information from the data. The Presentation Layer describes the manner in which content, questions, and results are displayed to the user. Depending on the choices and preferences of the user in the creation phase, the Presentation Layer may be static or dynamic. If static, the presentation presents a consistent flow and look, while still permitting dynamic branching. In other cases, the elements of the Presentation Layer are determined in real time and can be influenced by the state of the data, calculations, user identity or attributes, or data from outside sources. The system contemplates a broad definition of Presentation Layer, where the system my present content, data, or results to other systems through file downloads, web services, or other electronic means. In addition to accepting user input, the Presentation system can accept input from non-human sources, such as files, networks, web services, remote databases, and the like.

Navigation describes the process of determining which area of the program or Presentation to choose based on user input or decisions. The navigation system determines which page (internal to the application, or external) the user should go to next. This navigation determination is done in real time and can be influenced by the state of the data, calculations, user identity or attributes, or data from outside sources. The navigation subsystem also works in cooperation with the Data Structure to evaluate any constraints placed on that page submission and may report errors to the user. The navigation may also be tied to calculations in the Data Structure to create conditional and branching relationships between presentation options.

### BRIEF DESCRIPTION OF THE DRAWINGS

FIG. 1 is a block diagram of an embodiment of the authoring tool of the system.

FIG. 2 is a flow diagram illustrating the creation of pages.

FIG. 3 is a flow diagram illustrating the operation of the presentation editor.

FIG. 4 is an example of how the module tree structure is presented to a user in the application builder.

FIG. 5 illustrates the presentation of the page and section tree to a user in an embodiment of the application builder of the system.

FIG. 6 illustrates the presentation of page elements in one embodiment of the application builder of the system.

FIG. 7 illustrates the presentation to the user for editing data elements in one embodiment of the application builder of the system.

FIG. 8 illustrates the presentation for editing a calculated data element in one embodiment of the application builder of the system.

FIG. 9 is an embodiment of a computer execution environment where one or more embodiments of the present system maybe implemented.

FIG. 10 is a flow diagram of the operation of the system.

### DETAILED DESCRIPTION OF THE PREFERRED EMBODIMENTS

A system and method for building software applications is described. In the following description, numerous details are set forth in order to provide a more thorough understanding of the system. It should be understood that the system may be practiced without these specific details. In other instances, well known features have not been described so as not to obscure the system.

While there are many ways to segment a computer application, one approach would be to consider the following three elements of a computer application: (1) the content of the screens that are presented to the user, (2) the scheme which determines what screens to display next, (3) the logic system (Boolean, numerical, etc.) that is used to process information to/from the user and/or to/from other computers, stored data, or devices on a network.

The value in selecting the above decomposition is that the non professional programmer is familiar with metaphors and tools that are used to create each element. For example there are many metaphors and tools for creating screen content from document editors (MS Word, etc), PowerPoint, FrontPage, content management systems, graphics and drawing packages, etc. The second element is familiar to end users through metaphors with maps, flow charts, organization charts, recipes, driving directions or other metaphors and tools which show either a spatial or sequential relationship between multiple items. The third element is familiar to many through tools like Excel, Access, etc.

By selecting a decomposition that is aligned with a tool set that many non programmers are already familiar with, users will have less difficulty expressing their intent for the functionality of the application they desire to create. As the application author wants to check their work, or as their needs and desires for the functionality of the application change over time, the non programmer authors will be able to quickly and easily modify their previous work.

The disclosed system allows each element of the above decomposition to work together to result in a whole class of computer applications that are more powerful and flexible than any common tool by itself. For example input can be requested on a content page that is then used to drive the logic system and may result in changes to other content, navigation, or computed elements that are unique to that user's experience of the application.

The system provides an authoring tool and an application player to enable high level creation of interactive software applications. The system specifies screen content using a module, page, and paragraph metaphor. While an entire application could be built in one module, most often applications span several modules so that each individual module becomes a discrete, coherent unit of work. A module is comprised of one or more pages, which may or may not be grouped in sections. While a module may have only one page, typically modules are grouped into one or more sections requesting input, and one or more sections that reveal results based on that input. In other cases results interspersed with requests for more information is a useful pattern. A page is comprised of one or more paragraphs, notes, and attachments. While a module page may have only one paragraph, typically pages are divided into one or more logical paragraphs for ease in page maintenance. Module pages do not necessarily have notes or attachments. The elements of an application are created using an authoring tool.

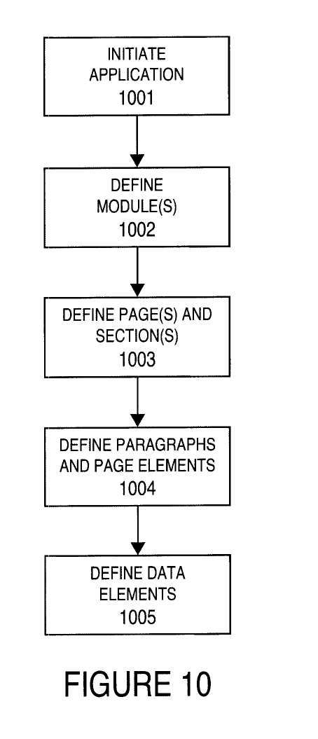

A flow diagram illustrating the authoring of an application illustrated in FIG. 10. Although FIG. 10 is illustrated as a flow chart, it is understood that there need not be any specific order to the steps. The user may iteratively through the steps in any order and may repeat steps as desired. The order of FIG. 10 is for example purposes only. At step 1001 the user initiates the system to create a new application. At step 1002 the user defines one or more modules that will be used with the application. At step 1003 the user defines one or more pages and sections for each module. At step 1004 the user defines paragraphs and page elements for each page. At step 1005, the user defines data elements for the page elements. At step 1006, the user uses the application player to utilize some or all of the application that was just created. The user then iterates as necessary through the above steps in any order until the application conforms to the desired result.

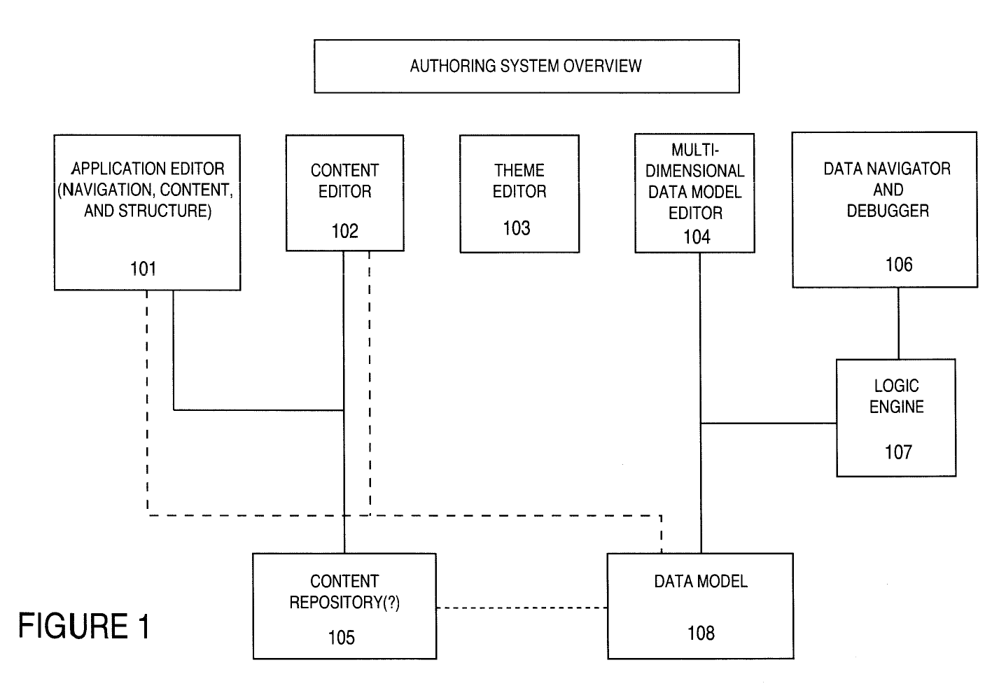

An embodiment of the application builder/authoring tool is illustrated in FIG. 1. The authoring tool comprises an application editor 101, content editor 102, theme editor 103, multi-dimensional data model editor 104, data navigator and debugger 106, logic engine 107, content repository 105 and data model 108.

Modules

The application editor 101 is used to create, edit, copy, rename, or delete an application. It can save or load (or import and export) an application to and from a file. The application editor 101 defines the scenario structure for an application. This function is used to initiate the file creation process at a high level, by naming the application. The application editor 101 can also be used to import or reference data, content, or data models from another pre-existing application if desired. The application editor can also be used to define modules that the user desires to use with the application. A module in the system is a container for pages related to a particular type of data or activity. For example, an expert system for financing car sales. There may be a module for the customer, one for the loan broker, and one for the administrator who is maintaining or verifying information such as loan rates. The modules can be nested and each can have their own related sub-modules as desired.

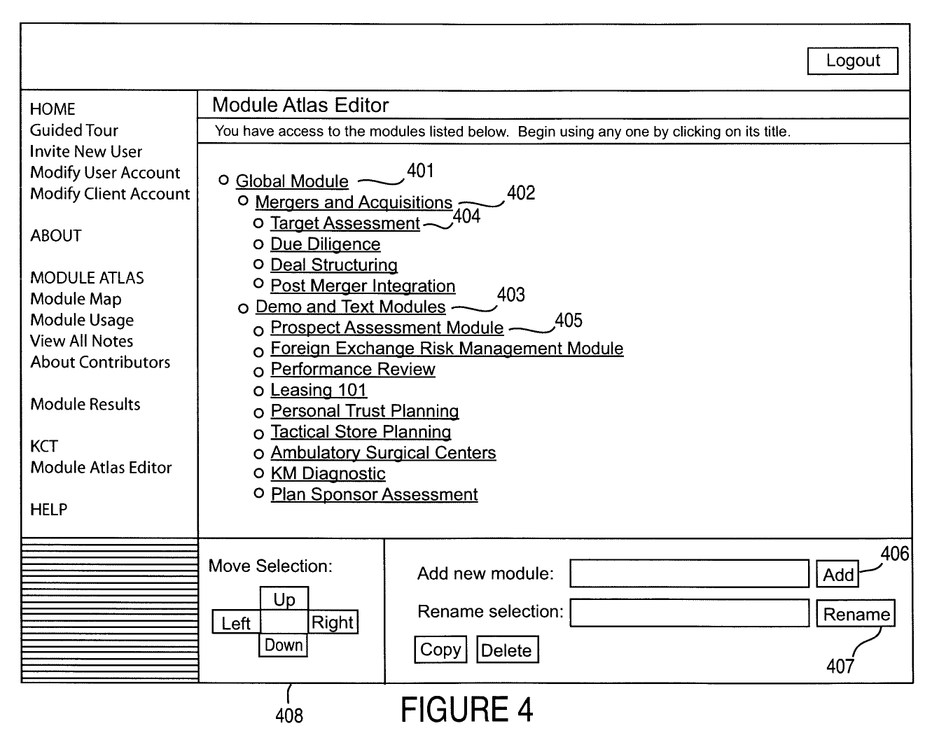

FIG. 4 is an example of how the module tree structure is presented to a user in the application builder. The highest level module 401 has two second level sub-modules 402 and 403. Sub-module 402 has its own nested sub-modules such as module 404. Similarly, sub-module 403 has its own nested sub-modules such as module 405. Radio buttons beside each module instance are used to indicate which one is currently active for manipulation or editing. An active module may be moved around in the tree structure using the directional buttons 408. The title of the module may be changed with Rename function 407. New modules are added via Add button 406. Modules can be copied if desired, which can be particularly useful when creating similar modules or sharing modules between applications.

Pages

As noted above, a module is comprised of one or more pages, which may or may not be grouped in sections. Pages can be grouped into one or more sections requesting input, and one or more sections that reveal results based on that input. Alternatively, intermediate and final results can be interspersed with requests for more information.

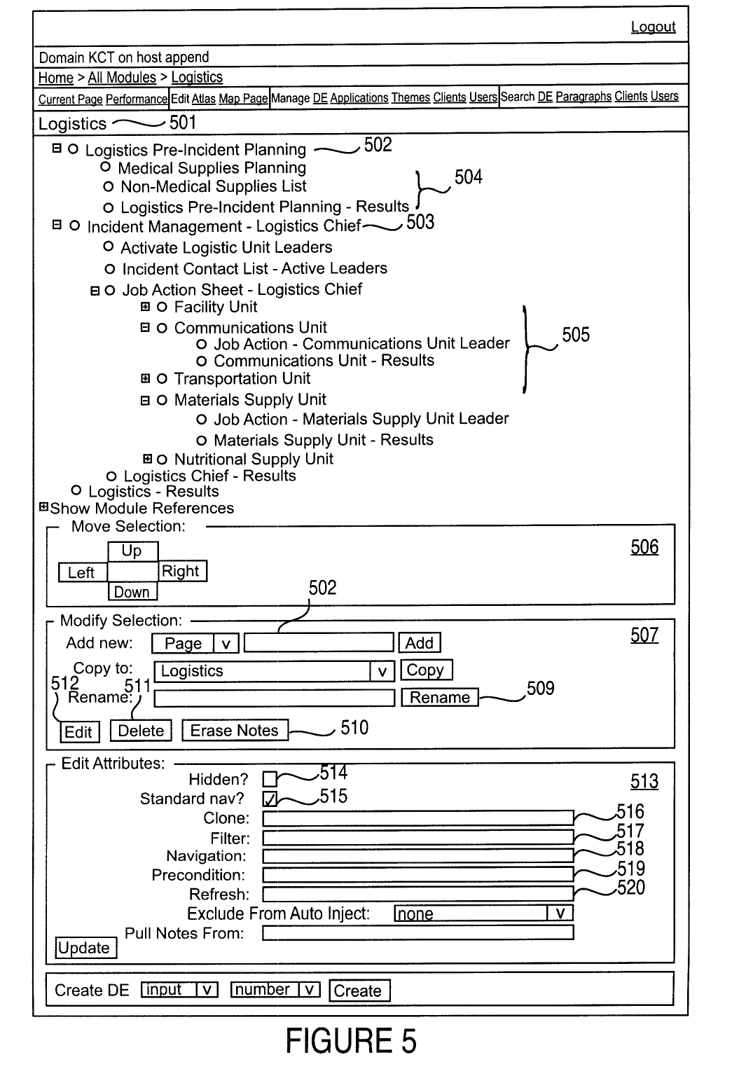

FIG. 5 illustrates the presentation of the page and section tree to a user in an embodiment of the application builder of the system. The top of the page indicates the name of the module 501 associated with the pages and sections. Some of the tree elements are individual pages such as pages 502 and 503. Some pages are grouped in sections such as sections 504 and 505. Sections are represented as having sub-pages in the hierarchy. As with the module presentation, the pages include radio buttons so that a user can know which page or section is currently active in the editor. The pages can be moved using the directional buttons 506. When a section of pages is moved, the children of that section will move along with it. Drop down menu 508 of modify section 507 is used to select between a page and a section for creation. A sub-page from a section can be moved out of the section to another section, or as a standalone page, as desired. Of course pages and sections may be copied as desired within the module or to other modules or applications. Pages may be renamed using control 509, control 510 allows all notes on the selected page for all users to be erased. Control 511 allows the selected page and all of it's children to be deleted. Control 512 opens the “Edit Attributes” panel 513 for the page whose radio button was selected. Control 514 specifies whether or not the specified page is shown in the module table of contents, also called the module map. Control 515 allows the default navigation scheme to be suppressed from display on each screen. Control 516 specifies an axis data element to be applied to this page as a “clone” attribute. An axis data element is a set of 0,1,or many values. For each value in that axis a unique version of that page is made available which is indexed by the associated unique value of the axis. Any data required to render that page like wise uses the associate value of the axis unique to that page. For example of an application has data associated with several product models whose names or model numbers are listed as values of an axis data element, a page may be cloned on that axis such that one page will be possible for each the data associated with each product model. Other data used to render the contents of that page will also use only the slice of the multi cube of data associated with the axis value for this page. Note that the cloning behavior can be unique to each user of the system even when multiple users are on the system at the same time. Similarly, control 517 specifies a filter data element that can be used with clone attribute to make available a set of cloned pages. Which pages are possible is defined by the value of the filter. On the above example, if a particular application end user was only interested in the information associated with a reduced set of the product modules, a filter could be applied thus making only available a reduced set of pages for navigation or display in the module map. Control 518 is the name of a data element or a logic formula which specifies which computes or specifies the page this user should be presented with next. If this attribute is omitted, then the user progresses through the pages in the module map tree in a depth first traversal. The control 519 is used to specify the formula or data element which computes or specifies the conditions under which this page is presented in the module map and made navigable to this particular end user. During the navigation process, this data element or formula is evaluated using the end user's unique personal set of data to determine whether the conditions exist such that this page will be displayed in the map or is navigable. Control 520 specifies an interval in seconds for which this page will automatically refresh itself while displayed to the end user. Control 521 specifies whether the multi dimensional data space used to render the associate page should sliced on the axis of “client” or “user”. That is, should all global data be available to render this page, or should only data associated with this particular user and her client group be made available. Attributes 514, 516, 517, 519 of a page are also passed on to a child page in the tree hierarchy of the module map. FIG. 5 shows a screen shot of one embodiment that is designed for use within a web browser with minimal advanced capabilities. Other embodiments use thin and thick clients for the editors or leverage javascript or AJAX techniques.

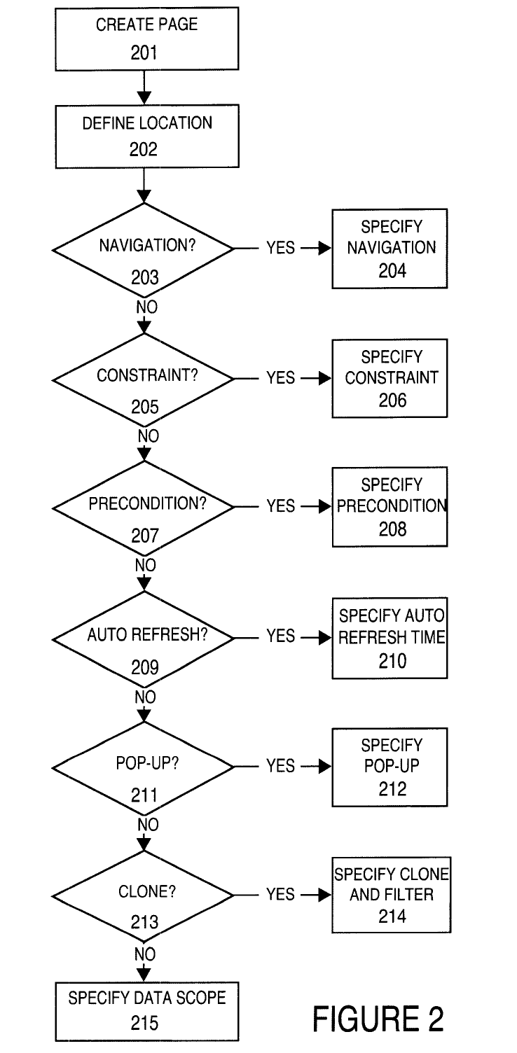

FIG. 2 is a flow diagram illustrating the creation of pages using the application outline and navigation workflow editor 101. Although FIG. 2 is illustrated as a flow chart, it is understood that there need not be any specific order to the steps. The user may iteratively through the steps in any order and may repeat steps as desired. The order of FIG. 2 is for example purposes only. This is used to create, edit, copy, rename or delete a page/screen from the application outline. When a page is created (step 201) a page list is maintained and displayed to the user. At step 202 the location or position of each screen within the application outline is defined. At step 203 it is determined if a navigation formula is to be applied when a user submits each page to determine which page should be shown next. (during application usage, this formula is evaluated in real time). If so, the navigation formula is specified at step 204. Otherwise, at step 205 it is determined if the user will specify an optional constraint formula(s) to be calculated when the user submits a page, violations of which result in errors reported to the user with corrective suggestions. If so, the constraint is defined at step 206.

Otherwise, at step 207, it is determined if the user specifies an optional precondition formula which controls whether the screen is available to this user in the absence of the precondition. For example, a page may require a certain amount of information be available before it would be useful or appropriate to display the page to the user (during application usage, this formula is evaluated in real time). If there is to be a precondition, the precondition is specified at step 208. This precondition may also reflect a security level for the page, with only certain tiers of users having permission to use the page.

At step 209 it is determined if the page should implement an interval (time) for the page to auto refresh. If so, the time interval is specified at step 210. At step 211 it is determined if the page is to be a pop-up page tied to one or more existing pages or if it should be a standalone page. If it is to be a pop-up page, that is specified at step 212. At step 213 it is determined if the page may be cloned. That is multiple copies created across the members of a data vector. If so, the page is specified as clone-able at step 214 and clone filters (optional) are defined. Note that the clone copies are created in real time depending on the specific values of each user's data vector. The filters may be defined on any clone dimension. For example, if only certain coordinates of a data axis are relevant to a user at a specific time, a static or calculated filter may be applied in real time to constrain the scope of the clone.

At step 215, the scope of data available to the body of the page is defined. The data model supports multi dimensional data, and the author may desire to limit the contents of a page to a subset of that space. For example, some pages might require global data to show summary data from multiple users of several applications; other pages might have content that only pertains to a certain year and country for data sets that span multiple years and countries (example of multi dimensional data).

Cloning is useful for certain types of multidimensional data. For example, if one of the data characteristics of a page was temporal data such as month or year, cloning the page using month as a filter would result in one page being created for each month of the year. The filter choices can be combined so that a page could be created for each month of each year, for example, if desired. As noted previously, the cloning can take place at run time and can be dependent on selections that a user makes during run time.

The navigation formula in steps 203 and 204 can be complex formulas with a series of conditions so that depending on user action during runtime, the page path could be any one of dozens or more pages. The pre-condition filter can be used in a number of different ways. For example, in one embodiment the runtime user can see a table of contents of available pages. The creator can set the precondition filter so that the page shows up in the table of contents but is not selectable unless certain conditions are met. In other instances, the page does not even show up in the contents unless the conditions are met.

In one embodiment, during creation of pages, other pages are displayed in a tree list and have an indicator (i.e. a radio button) next to them so that one page can be selected. When a page is selected, its attributes are displayed in an associated area so the creator or programmer can easily modify the page as desired. In addition, when the page is selected, it is easy to move the page up or down or left or right in relation to the other pages in the contents so that navigation and relationships are easily modified.

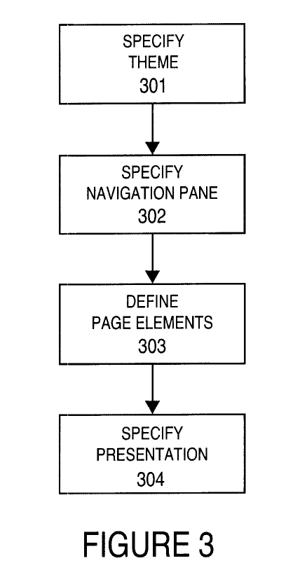

The Presentation Editor is used to define the make up of each screen(s) presented to the user and is implemented via the content editor 102, theme editor 103 and content repository 105. It includes a broad definition of presentation, where the system my present content, data, or results to other systems through file downloads, web services, or other electronic means. The operation of the presentation editor is illustrated in the flow diagram of FIG. 3.

At step 301 the user specifies a “Theme” or “Skin”. This is the general color palette, font, icons, logos, CSS (cascading style sheet) classes, headers and footers, that are common to all pages in the module. A theme can be unique to a particular module, or completely or partially shared among modules if desired. In one embodiment, complete themes are stored in a theme library and the user selects from one of the selections. In another embodiment, the user is presented with all theme options and selects each one independently. For example, the user is invited to select the color, followed by the font, logos, etc. adding to the customizability of the pages in the module or application.

At step 302 the user specifies an optional navigation pane or panes: This is commonly a panel on the left of the screen or a region across the top of the screen that is common to all screens and that allows the user to access functionality or navigate directly to a specified screen.

At step 303 the user defines the specification of the elements of the page or screen body. This area is made up of a combination of a number of elements and is described in more detail in FIG. 4.

At step 304 the user defines the specification of electronic “presentation” where the consumers of the content or providers of input data are files, web services, or other electronic means.

Page Elements

A page is comprised of one or more page elements referred to as paragraphs, notes, and attachments. While a module page may have only one paragraph, typically pages are divided into one or more coherent paragraphs for ease in page maintenance. Module pages do not necessarily have notes or attachments.

The page elements that can be defined in the application building stage by the user include a number of predetermined page elements. Although certain of these page elements are referred to as “paragraphs” they are not paragraphs in the grammatical sense. Rather they are logical subsections of the logical element known as a page.

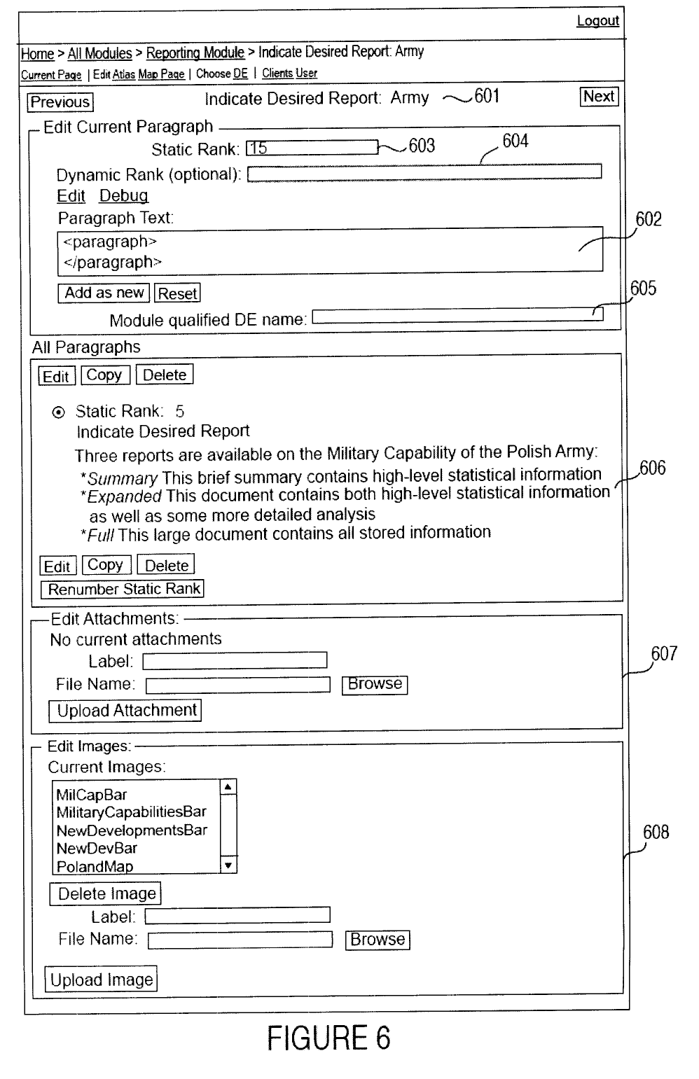

FIG. 6 illustrates the presentation of page elements in one embodiment of the application builder of the system. The page name 601 is presented at the top of the display. A new/edited paragraph area 602 is typically empty until an existing paragraph is created or edited. Region 603 displays the static rank of the current paragraph while region 604 displays the optional dynamic rank. The page element may have a fixed location on the element tree or it may have a dynamically changing position in the hierarchy of the other page elements as desired. Static paragraph ranks are numbers that indicate a fixed order of presentation (with lower, positive numbers first). Each static rank number creates a “zone” in which a variable number of paragraphs can exist. A page can have an unlimited number of static rank “zones.” Dynamic paragraph ranks are determined by calculated data elements, whose values determine in which order paragraphs appear within a given static rank “zone” (with higher, positive numbers appearing first).

Paragraph bodies consists of XML tags which determine the structure and and formatting information in a paragraph. Region 602 can be used to enter XML code for controlling features of the paragraph and other page elements. In one embodiment, an XML dialect is used referred to here as KPML. Other embodiments use a WYSIWG editor to hide the details of the XML tags from the application author.

KPML is automatically formatted when displayed in the editor window. Each paragraph begins with the <paragraph> and end with the </paragraph> tags.

Some sample KPML tags include:

Paragraph headers: Paragraph headers serve as subtitles on a page and are displayed in a larger, boldfaced, and underlined type to indicate new ideas.

Example: <header>Five-Year Business Plan</header>

Text blocks: Text paragraphs begin with the KPML tag <block> and end with the KPML tag </block>. The following are examples.

| Item | KPML Tag | Output |
|---|---|---|
| Bold | <bold>word</bold> | word |
| Italic | <italic>word</italic> | word |
| Bullet | <ul> | word |
| (unordered list) | <li>word</li> | word |
| | <li>word</li> | |
| | </ul> | |
| Bullet | <ol> | 1. word |
| (ordered list) | <li>word</li> | 2. word |
| | <li>word</li> | |
| | </ol> | |
| Sub-bullet | <ul> | Employees |
| (unordered list) | <li>Employees</li> | Bob |
| | <ul> | Nancy |
| | <li>Bob</li> | Salary |
| | <li>Nancy</li> | |
| | </ul> | |
| | <li>Salary</li> | |
| | </ul> | |
| Internal Hyperlink | <jump page=”equity sharing”>Equity Sharing</jump> | Equity sharing |
| External Hyperlink | <link pageURL=”http://www.mellon.com”>MellonBank</link> | Mellon Bank |

Section 606 displays the existing paragraphs and page elements of the page under consideration. This permits the user to easily see the hierarchical relationship of the paragraphs and to select one of the paragraphs for editing. Regions 607 and 608 are used to add or edit attachments to the page. There are browse buttons that provide a list of available attachments and images to be inserted by the user. Each module paragraph can have a variable number of tables that are either static or dynamic (driven by the data model). A table is composed of columns and rows. In KPML for a static table, each column is a separate series and the rows are built by adding additional cells.

These elements are not meant to be exhaustive but are given by way of example. One page element is defined for static text elements. These are titles, headers, or other informational text elements that do not change on the page with other data changes or conditions. The user can also select and position binary display elements such as images, videos, flash animations, and the like. In one embodiment, the paragraphs/page elements are also presented as a content list so that the user can see at a glance the hierarchical relationship among and between the paragraphs.

Graphs and charts based user, calculated, or external data can be defined and inserted. (These can be multi dimensional and allow the user to sort or change the dimensional layout as they desire). Tables may also be selected and may be sortable if desired. The tables may be multi dimensional and allow the user to sort or change the dimensional layout as they desire.

Another page element is dynamic text. This is text that is a result of calculations and may be unique to this particular viewing of this screen. The user can insert requests for user (runtime user) input and input fields (these may include text, numeric, dropdown, check boxes, radio buttons, file uploads, and the like). The user may also select a page element to display previous inputs or the results of calculations (numeric, logical, string manipulation, and the like).

If desired, the page can be configured to display data dynamically sourced from other systems, such as from web pages, databases, and the like. Or the user can insert a selection of attached or linked files, (documents, spreadsheets, programs, video clips, etc) that the user can select and view or download. The selection, ordering, and presentation may be dynamically controlled by conditional or ranked control elements. The user can insert buttons or links for actions, including submitting input data, jumping directly specified subject areas, and the like. Often this can be done by creating a flag condition for the page.

Page elements can include the conditional display or re ordering of any of the above content segments based on static data, user input or calculations. The page content/display changes based on calculations and every page is constructed in real time.

An alternative implementation is to prepare a content fragment when the data changes so they are ready when needed. Depending the type of application being built and how much the data is changing one or the other maybe more efficient. If desired, pre calculation may be accomplished in the background, or a monitor may track rate of change of data and choose the right algorithm for each content element. As with page cloning and filtering described above, individual page elements can be cloned and filtered as well. This can be a duplication of a segment of content, where each copy has a different data coordinate applied across one or more dimensions. The data elements can be segmented (content segmentation) in order to apply the above condition/ranked/cloned controls on the content, and arbitrary subset of the page content can me specified to be influenced by the control.

Different forms of data input can be configured as part of the paragraph and page content. Input can be as simple as a question with space for a single response, URLs and URIs, formatted input cells arrangements, tables, text areas, areas for cutting and pasting content from other applications, references to data on other web pages, databases, or internet services, and file uploads. These inputs have all the customary variants of visual display, input fields, drop down menus, radio buttons, etc. It is understood that these are examples only, and the system is not limited to these inputs.

A variant of the data input capabilities is the ability to add, delete, or modify the coordinates of a data access as part of paragraph. The can either be done explicitly by the user by creating, editing, deleting an entry in a editable field, or indirectly through a specified button or action that may append or modify the value of a data element or coordinates of a axis with an incremented index, time stamp, data value on a remote system, or result of a specified calculation.

Data Model and Calculation Editor (Logic Subsystem)

This subsystem, implemented via multi-dimensional data model editor 104, data navigator 106 and data model 108, utilizes data and information provided by a module user, data and information provided by other system users, information and data acquired from external sources, and data, information, and formulaic relationships specified by the module author. This data and information is used by the formulas to derive new data and information. This derived information is used to control the elements of the presentation, navigation, and workflow described above.

We use the term “data element” herein to include scalar values as well as multi-dimensional values. Also the values can be numeric, Boolean, text, character strings, or binary. Data elements are organized into data structures or data models. Data elements can contain values provided by one or more users, calculated by the system, or sourced external to the application, e.g. data files, outside databases, networks, web services, etc. Each page or paragraph can have its own associated data elements. In addition, the data elements, just as with the pages and paragraphs, are presented to the user in a list (table of contents in a tree format) so that the user can select a data element and easily see its hierarchical relationship to other data elements.

Data elements are cataloged according to the module in which they were entered:

“Module Name|DE Name” or [Module Name|DE Name] or [DE Name]

Data elements come in one of two classes: input and calculated

Input Data Elements

The input data element is the most basic class of element in the system, and is used to directly obtain user input. Input data elements have the following attributes:

Axes: The list/set of dimensions in which the data element resides.

Value Type: every data element must have a basic type:

Number (integer or with specified or automatic decimals)

Text

Flag (displayed as either a drop-down menu or checkbox)

Choice of selections (displayed as a drop-down menu)

Image (.gif or .jpg)

Document

Value: The actual value entered by the users.

Default Value (optional): For each type of value, a default value can be entered in the system that can be changed by the user. Note that a default value is not available for calculations until it has been submitted by a user, it is only a pre-fill to an input data element not yet submitted. The default value my be a static value (a literal), or it maybe the result of a calculation, or a reference to data on another system on the internet.

Initial Value (optional): This is similar to the default value, except that it is available for calculations even if not submitted by the user.

Certainty: Data elements have a certainty value (input by the user) that reflects the user's sense of confidence in his or her input. Certainty can have the following values (0%—uncertain to 100%—certain)

The data elements can be displayed and listed by page if desired. In another embodiment, all data elements from the entire application can be listed. They can also be sorted and displayed by type or by other

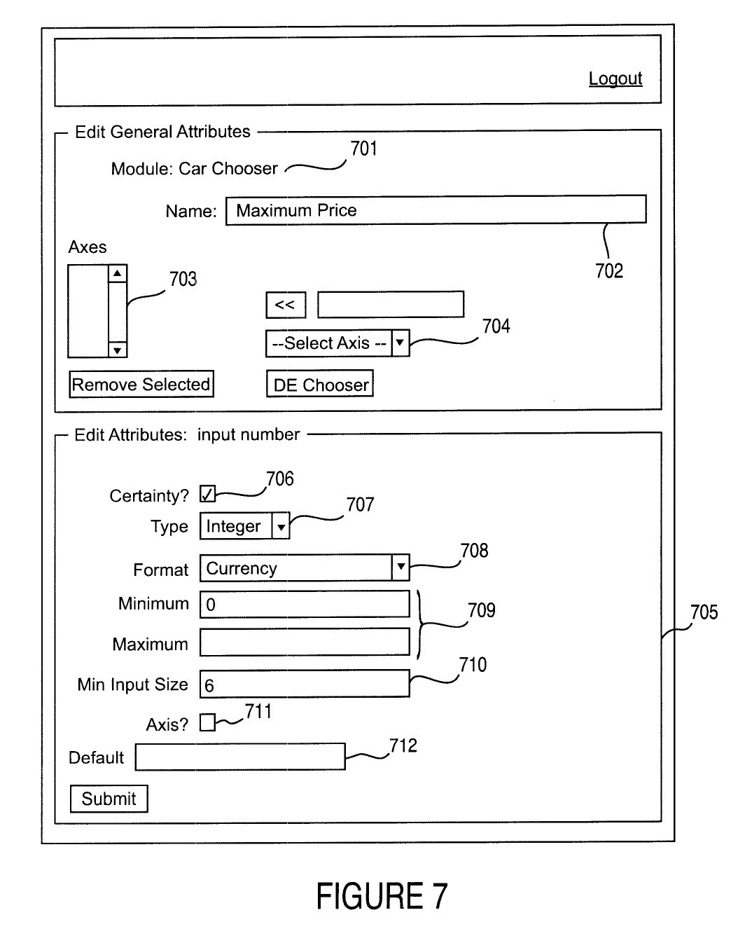

FIG. 7 illustrates the presentation to the user for editing data elements in one embodiment of the application builder of the system. This portion of the authoring tool provides for the ability to take a number of actions with respect to the data elements. The module associated with the data element is shown at 701. The name of the data element is shown at 702. The user can create, edit, delete, or copy data elements. (copy to/from other applications or data sets). The user can optionally specify at 704 whether this data element can be used as an “axis” for dimensional specification. Optionally the user can specify the dimensional constraints 703 on the data element. Note, if a data element can be used as a dimension, it can also have dimensional constraints as well. In this case it would be a nested dimension. For example, there may be a data element whose values are the US states. There might be a nested dimension for that data element whose values are counties. Therefore the set of values for “county” would be unique to the specific coordinate of its parent dimension of state.

Optionally, in region 705, a certainty value 706 may be paired with each scalar value. The certainty is either entered by the user (or external file/system/web service) when the data is entered, or is the result of the certainty of the operands of a calculation.

The user may specify minimum or maximum lengths or values 709 of a string, numeric values, or number of values for multi valued data elements. The user can also specify zero, one, or more default values 710. The defaults can be literal values, or calculated values. The format 710 and type 707 are selectable from pull down menus in one embodiment.

The tool includes a data element debugger that shows the values for the current data element, provides the data description (and formula for calculated values) of the operands used in the formula, and shows the pages and formulas that use this data element. This allows the user to easily check and edit data elements at build time instead of runtime.

Calculated Data Elements

Calculated data elements are the result of a formula or function (a general expression that performs operations on data elements) that combines other data elements or fixed (“literal”) values. Calculated data elements have the following attributes:

Value Type: every data element must have a basic type

Number: calculated numeric data elements are the most straightforward type of the calculated data elements, and reflect a numerical calculation using formulas or functions.

Text: For calculated data elements, text can be combined into concatenated strings (phrases) using an addition formula.

Flag: The calculated flag data element returns a true/false result.

Value: The actual value calculated by the system.

Certainty: Calculated data elements have a certainty value (calculated by the system), which reflects the calculated sense of confidence the user should have in the value generated by the system.

Axes: The list/set of dimensions in which the data element resides.

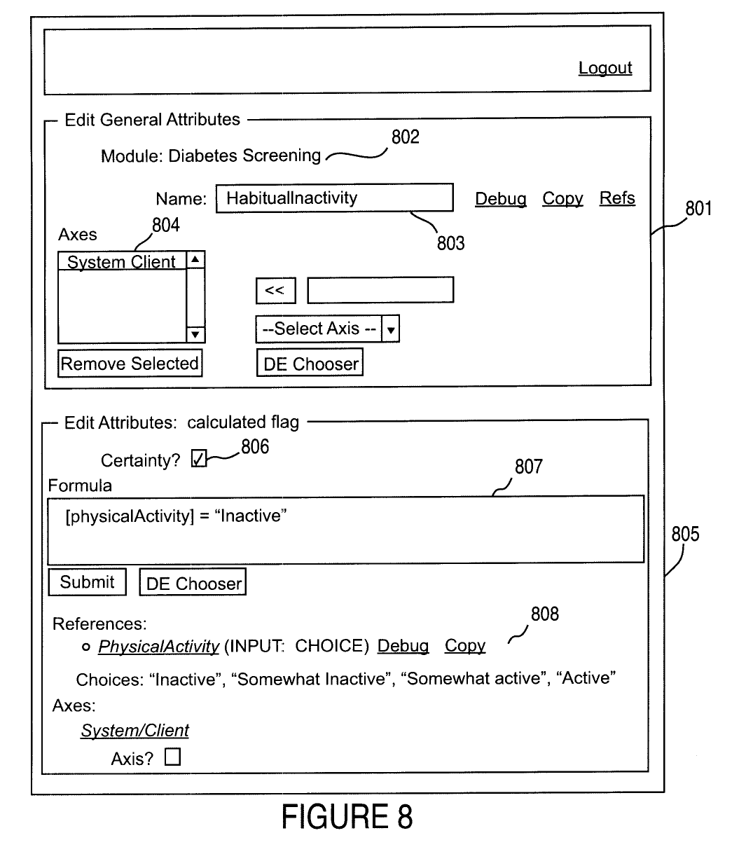

FIG. 8 illustrates the presentation for editing a calculated data element in one embodiment of the application builder of the system. General attributes 801 of the calculated data element includes the module 802 that contains the data element. The name 803 of the data element and the axes 804 of the data element are configurable in this section. The certainty 806 of the data element is set in formula box 805. The actual formula itself is entered in 807. Details of relevant and related data elements 808 are shown below the formula entry region.

The formulas that can be entered for a data element are limitless. Two by way of example are a calculated flag (Boolean) and calculated number data element. For example, it may be useful to know whether the user in our module is male or female. A yes or no answer to the question: is this user male can be calculated. Its formula would look like this

If([User Gender]=“male”,“Yes”,“No”)

or a more simplified version

[User Gender]=“male”

Calculated number data elements must evaluate to a number, so their formulas must read such that this is true. For example, it may be useful to know how old the user will be in ten years. The calculated number data element's formula would look like this:

[User Age]+10

The system has all the customary functions that one would find in applications such as Excel, Applix, or Quantrix.

Axes and Cloning

Imagine a user who wishes to conduct financial analysis on potential acquisition candidates. We might imagine that they would be interested in creating the following table:

| | Year 1 | Year 2 | Year 3 |
|---|---|---|---|
| | Revenues | Revenues | Revenues |
| Company 1 | 10.1 | 10.2 | 10.3 |
| Company 2 | 5.1 | 5.5 | 5.9 |
| Company 3 | 3.3 | 3.2 | 3.1 |

To capture this data, we could create an input number data element for each combination (a total of nine), but that would be quite time consuming if we wanted to collect more data than just revenues. Moreover, suppose the user wanted data for more than 3 years or more than 3 companies. It would be quite cumbersome to create and maintain all of those data elements.

The system provides a technique to accomplish this using dimensions and by dimensionalizing the data.

An axis is a list of values that serves as a dimension for other values. In our example above, Year and Company are two dimensions on the values of revenues. To create a text list input by a user, designate an Input Text data element as an axis.

Functioning hand-in-hand with axes are the <clone> and </clone> tags, which are used to replicate anything that appears within them for each axis value. Clone tags can be used to input and display data elements that are dimensionalized along an axis. Cloning can be applied at the module, page, paragraph, section, and data element level.

Example Axes-Related Functions

While most functions will operate within an axis (or no axis at all), a number of functions are designed to operate across axes:

MIN (<NumberDE>, <AxisDE>): function takes an individual data element defined on an axis and an axis data element which must exist in the previous data element's axis list as its arguments. It returns the minimum value of all of the NumberDE data element found when scanning the axes defined by AxisDE. Note that if NumberDE has one dimension which is the same as AxisDE, then this function will return a single scalar value. Both NumberDE and AxisDE may optionally be multi-dimensional and thus the result of this functional my itself be multidimensional where the resulting dimension is defined as the space of NumberDE minus the space of AxisDE.

MAX (<NumberDE>, <AxisDE>): function takes an individual data element defined on an axis and an axis data element which must exist in the previous data element's axis list as its arguments. It returns the maximum value of all of the NumberDE data element found when scanning the axes defined by AxisDE. Note that if NumberDE has one dimension which is the same as AxisDE, then this function will return a single scalar value. Both NumberDE and AxisDE may optionally be multi-dimensional and thus the result of this functional my itself be multidimensional where the resulting dimension is defined as the space of NumberDE minus the space of AxisDE.

SUM (<NumberDE>, <AxisDE>): function takes an individual data element defined on an axis and an axis data element which must exist in the previous data element's axis list as its arguments. It returns the sum of all of the NumberDE data element found when scanning the axes defined by AxisDE. Note that if NumberDE has one dimension which is the same as AxisDE, then this function will return a single scalar value. Both NumberDE and AxisDE may optionally be multi-dimensional and thus the result of this functional my itself be multidimensional where the resulting dimension is defined as the space of NumberDE minus the space of AxisDE.

AVG (<NumberDE>, <AxisDE>): function takes an individual data element defined in an axis and an axis data element which must exist in the previous data element's axis list as its arguments. It returns the average of all of the NumberDE data element found when scanning the axes defined by AxisDE. Note that if NumberDE has one dimension which is the same as AxisDE, then this function will return a single scalar value. Both NumberDE and AxisDE may optionally be multi-dimensional and thus the result of this functional my itself be multidimensional where the resulting dimension is defined as the space of NumberDE minus the space of AxisDE. These are given as examples only and not intended to be limiting. It should be noted that axes can be nested where an axes may have sub-axes that are related to and associated with the top level axis.

There are some parallels between the described calculation data element editor and calculation system and common tools like Excel. For high dimensional data modeling one might turn to Quantrix. However, both Quantrix and Excel fail at serving transactionally secure multi-client calculations. Similarly large OLAP systems that can handle high dimensionality data are designed for use on static data sets, so require either data re-importing or re-indexing after data is changed before they can service requests. The described system is designed to allow changes to data model and data values in real time. Changes to the data model might include adding, deleting, or editing data elements, data element dimensions, formulas, data dimensions (axes), or values.

### Embodiment of Computer Execution Environment (Hardware)

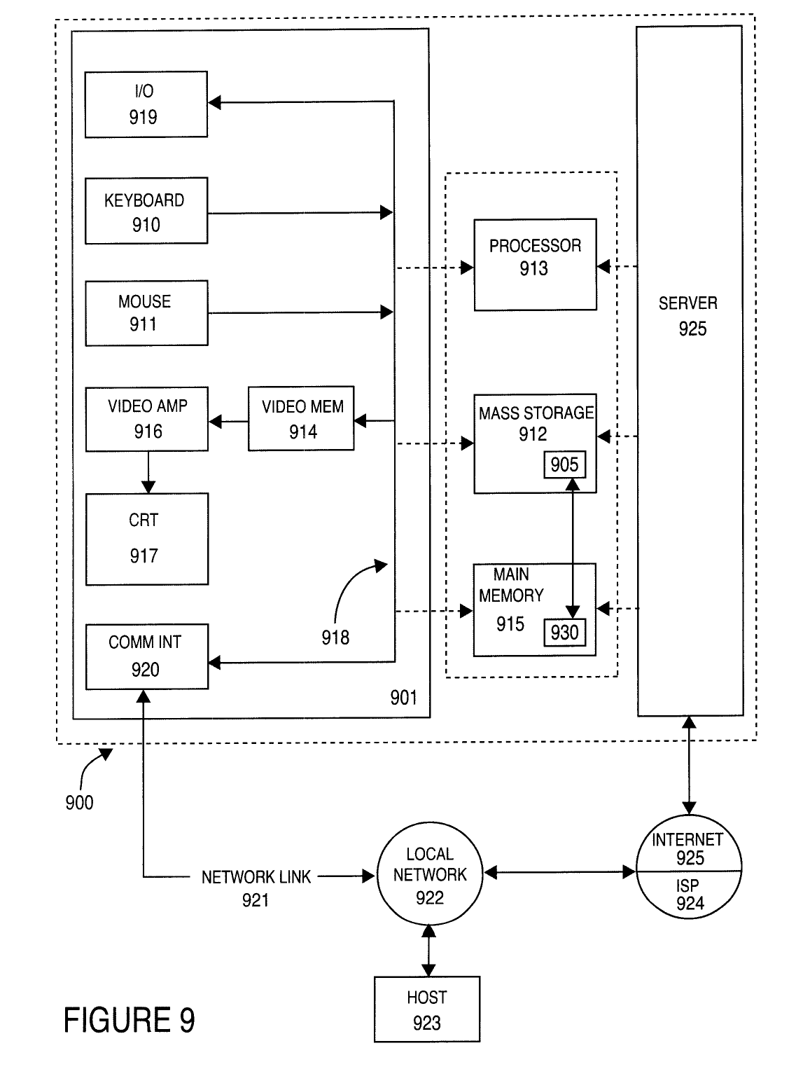

An embodiment of the system can be implemented as computer software in the form of computer readable program code executed in a general purpose computing environment such as environment 900 illustrated in FIG. 9, or in the form of bytecode class files executable within a Java™ run time environment running in such an environment, or in the form of bytecodes running on a processor (or devices enabled to process bytecodes) existing in a distributed environment (e.g., one or more processors on a network). The system may also be implemented on any suitable computing device such as a PDA, mobile phone, mobile computing device, as a software service hosted on a server, an ethereal network based implementation, or any other suitable processing environment.

A keyboard 910 and mouse 911 are coupled to a system bus 918. The keyboard and mouse are for introducing user input to the computer system and communicating that user input to central processing unit (CPU) 913. Other suitable input devices may be used in addition to, or in place of, the mouse 911 and keyboard 910. I/O (input/output) unit 919 coupled to bi-directional system bus 918 represents such I/O elements as a printer, A/V (audio/video) I/O, etc.

Computer 901 may include a communication interface 920 coupled to bus 918. Communication interface 920 provides a two-way data communication coupling via a network link 921 to a local network 922. For example, if communication interface 920 is an integrated services digital network (ISDN) card or a modem, communication interface 920 provides a data communication connection to the corresponding type of telephone line, which comprises part of network link 921. If communication interface 920 is a local area network (LAN) card, communication interface 920 provides a data communication connection via network link 921 to a compatible LAN. Wireless links are also possible. In any such implementation, communication interface 920 sends and receives electrical, electromagnetic or optical signals which carry digital data streams representing various types of information.

Network link 921 typically provides data communication through one or more networks to other data devices. For example, network link 921 may provide a connection through local network 922 to host computer 923 or to data equipment operated by ISP 924. ISP 924 in turn provides data communication services through the world wide packet data communication network now commonly referred to as the “Internet” 925. Local network 922 and Internet 925 both use electrical, electromagnetic or optical signals which carry digital data streams. The signals through the various networks and the signals on network link 921 and through communication interface 920, which carry the digital data to and from computer 900, are exemplary forms of carrier waves transporting the information.

Processor 913 may reside wholly on client computer 901 or wholly on server 926 or processor 913 may have its computational power distributed between computer 901 and server 926. Server 926 symbolically is represented in FIG. 9 as one unit, but server 926 can also be distributed between multiple “tiers”. In one embodiment, server 926 comprises a middle and back tier where application logic executes in the middle tier and persistent data is obtained in the back tier. In the case where processor 913 resides wholly on server 926, the results of the computations performed by processor 913 are transmitted to computer 901 via Internet 925, Internet Service Provider (ISP) 924, local network 922 and communication interface 920. In this way, computer 901 is able to display the results of the computation to a user in the form of output.

Computer 901 includes a video memory 914, main memory 915 and mass storage 912, all coupled to bi-directional system bus 918 along with keyboard 910, mouse 911 and processor 913. As with processor 913, in various computing environments, main memory 915 and mass storage 912, can reside wholly on server 926 or computer 901, or they may be distributed between the two. Examples of systems where processor 913, main memory 915, and mass storage 912 are distributed between computer 901 and server 926 include the thin-client computing architecture developed by Sun Microsystems, Inc., the palm pilot computing device and other personal digital assistants, Internet ready cellular phones and other Internet computing devices, and in platform independent computing environments, such as those which utilize the Java technologies also developed by Sun Microsystems, Inc. XML DOM trees and identifiers for the nodes in the DOM trees maybe stored in main memory 915 with a cache 990. Objects removed from the cache may be stored in an area 995 of mass storage 912.

The mass storage 912 may include both fixed and removable media, such as magnetic, optical or magnetic optical storage systems or any other available mass storage technology. Bus 918 may contain, for example, thirty-two address lines for addressing video memory 914 or main memory 915. The system bus 918 also includes, for example, a 32-bit data bus for transferring data between and among the components, such as processor 913, main memory 915, video memory 914 and mass storage 912. Alternatively, multiplex data/address lines maybe used instead of separate data and address lines.

In one embodiment of the system, the processor 913 is a microprocessor manufactured by Motorola, such as the 680X0 processor or a microprocessor manufactured by Intel, such as the 80X86, or Pentium processor, or a SPARC microprocessor from Sun Microsystems, Inc. However, any other suitable microprocessor or microcomputer maybe utilized. Main memory 915 is comprised of dynamic random access memory (DRAM). Video memory 914 is a dual-ported video random access memory. One port of the video memory 914 is coupled to video amplifier 916. The video amplifier 916 is used to drive the cathode ray tube (CRT) raster monitor 917. Video amplifier 916 is well known in the art and maybe implemented by any suitable apparatus. This circuitry converts pixel data stored in video memory 914 to a raster signal suitable for use by monitor 917 Monitor 917 is a type of monitor suitable for displaying graphic images.

Computer 901 can send messages and receive data, including program code, through the network(s), network link 921, and communication interface 920. In the Internet example, remote server computer 926 might transmit a requested code for an application program through Internet 925, ISP 924, local network 922 and communication interface 920. The received code may be executed by processor 913 as it is received, and/or stored in mass storage 912, or other non-volatile storage for later execution. In this manner, computer 900 may obtain application code in the form of a carrier wave. Alternatively, remote server computer 926 may execute applications using processor 913, and utilize mass storage 912, and/or video memory 915. The results of the execution at server 926 are then transmitted through Internet 925, ISP 924, local network 922 and communication interface 920. In this example, computer 901 performs only input and output functions.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

The computer systems described above are for purposes of example only. An embodiment of the system may be implemented in any type of computer system or programming or processing environment.

Thus, a system and method for creating software applications has been described.

What is claimed is:

1. A method of building applications comprising:
defining a presentation layer that describes the manner in which content, questions, and results are displayed to a user;
defining a navigation layer that describes which area of the presentation layer to choose based on user input or decisions;
defining a data structure that includes data and logic, rules, and formulas that derive information from the data and are associated with the navigation layer. xxx

2. The method of claim 1 further wherein the presentation layer is comprised of one or more pages

3. The method of claim 2 further including a plurality of paragraphs associated with each page.

4. The method of claim 3 further including a plurality of data elements associated with each paragraph.

5. The method of claim 3 wherein certain of the plurality of pages are grouped in a section.

6. The method of claim 5 wherein the presentation of at least one of the plurality of pages is determined pursuant to a precondition that controls the presentation of the page.
